(19) United States
(12) Patent Application Publication
(10) Pub. No.: US 2011/0059269 A1
(43) Pub. Date: Mar. 10, 2011

(54) Matboard having textured surfaces

(76) Inventors: Michael Paul Baratto, Marine On The St. Croix, MN (US); Eugene Louis Baratto, Somerset, WI (US); Sara Jo Griffin, Hudson, WI (US)

(21) Appl. No.: 12/584,453

(22) Filed: Sep. 4, 2009

(51) Int. Cl. A47G 1/12; B32B 3/00; B29C 51/10; B05D 5/00

(52) U.S. Cl. 428/14; 428/141; 264/101; 427/256

(57) ABSTRACT

A mat, and a method for making a mat, having a textured surface optionally colored and optionally laminated to a substrate. A mold containing relief characteristics is used to form a flat thermoformable layer into a thermoformed layer with the same relief characteristics as the mold. The mold is subsequently used to create a plurality of thermoforms, all of which, have the same relief characteristics, and may be colored or finished with or without patterns prior to forming the thermoformable layer or after forming the thermoformable layer. The process allows for the making of mats comprised of the same texture and unlimited variable colored finishes. The mats of the invention are useful for a variety of applications including, but not limited to, wall tile, floor tile, ceiling tile and mats used as a background or perimeter surround for image displays. Additionally, the invention provides for a decorative frame molding comprised of a rigid member covered with textured mats of the invention.

### BACKGROUND

1. Field.

The present invention relates, generally, to art and picture framing systems, apparatus and methods. More particularly, the invention relates to matboard systems, apparatus and methods. The techniques of the invention can also be used in other fields such as invitations, announcements, stamping, stationary, scrap-booking, albums, portfolios, calendars and other media.

2. Background Information.

The following terms, defined immediately below, have such meaning throughout the background, description and claims:
Mat—a sheet or film of material having decorative design characteristics the surface of which may or may not be textured.
Mold—a physical device having a decorative relief surface used to shape a substance.
Molded—having been shaped.
Molding—the process of shaping
Matboard—a term used in the framing market to describe a mat used as a decorative perimeter surround for art, prints, and numerous other image presentations.
Thermoformable layer—a flat plastic film or sheet that can be molded into shapes by the use of heat and pressure.
Thermoform—a thermoformable layer that has been formed into shapes having relief characteristics.
Intrinsic color—refers to the color of a material, where the color is throughout the body of the material, and is an inherent part of the material.
Extrinsic—refers to the color of a material, where the color is on a surface of the material, and is not an inherent part of the material.
Finish—patterns, designs or images of one or more colors applied to a surface.
Colored—refers to finishes and patterns comprised of a color or colors.
Highlighting—a hand or mechanical wiping of an wet colored layer used to create a variety of visual effects, or the application of color in specific areas to create special effects.
Master model—a form with a textured surface used as the model from which a mold is made. The surface of the master model may or may not be finished.
Hand—the degree of flexibility in a plastic material expressed in terms of very soft, soft, flexible, semi rigid, and hard.
Liner—a frame comprised of a rigid member having a decorative surface.
Perimeter surround—the area surrounding a display and disposed between the display and an outer frame, or frames.

Although the invention is useful for a variety of applications such as wall tile, floor tile, ceiling tile, accent strips, and other architectural surfaces and the like, the invention is particularly useful as textured decorative surrounds for the display of images such as photographs, prints and works of art, which are commonly referred to as matboards, and numerous craft items such as invitations, announcements, stamping, stationary, scrap-booking, albums, portfolios, calendars.

Matboard is commonly used to enhance the display of pictures and works of art. Typically, matboard is used in conjunction with a frame normally constructed of rigid materials. In addition to providing enhanced aesthetics, matboard when used in conjunction with rigid framing materials, reduces the expense of framing materials. To accommodate aesthetic requirements, framing a work of art or picture without matboard typically requires framing materials that are wider, heavier appearing, more complex in design, and more costly. Typically the design and cost requirements for rigid framing components can be reduced by incorporating matboard of appropriate designs as part of the framing construction.

Standard matboard is essentially a paper product made from wood pulp containing lignin, which causes the fibers in the matboard to become acidic and eventually leads to discoloration and degradation. With the addition of buffering agents such as calcium carbonate, the acid in the wood pulp can be neutralized and retarded, and discoloring and degradation can be minimized and retarded, but eventually degradation and discoloration will return due to UV light and oxidants in the air. Archival grade matboard, which is highly resistant to discoloration and degradation, is made from cotton, which doesn't contain lignin. Matboard made from cotton is typically referred to as rag board or Museum Board. Museum Board is a premium product that is used when framing high valued articles of art.

Standard matboard is used primarily in the decorative segment of the art, photograph, and print markets. Typically these matboards are two-dimensional and are available in a variety of colors, the surface of which is flat and non-textured. Most often the surface of matboard of this kind is printed with a pattern that may or may not impart the appearance of patterns and texture. Three dimensional matboard is available in simple low level textures, and is made by embossing the surface of paper based constructions with metal embossing rolls, examples, of which, are leaves, flowers, and stripes. More expensive commonly available materials such as linen, burlap, silk, and other fabrics are often laminated to rigid substrates and are used as higher-end matboard (perimeter surrounds). Very high-end original works at times do not employ matboard as a perimeter surround, and are presented with perimeter surrounds that are created by hand. Hand created perimeter surrounds can be flat two-dimensional or textured three-dimensional surfaces; colored or not colored, and are limited in design only by the imagination of the artisan that creates them.

Although there has always been a consumer inclination for matboard designs that combine color with three-dimensional texture, the demand for designs of this kind have been trending upward since the turn of the twenty first century. The two largest producers of matboard in the United States, Nielsen Bainbridge, Paramus, N.J. and Crescent Cardboard Company, Wheeling, Ill., have recognized the consumer preference for textures, and both companies have introduced new lines of three dimensional matboard, all of which have dimensionally low levels of texture that were produced by the embossing of paper or cotton based materials. As a result the product lines of companies selling textured matboards are all simple low relief textures with broad peaks and none of the products available for sale exhibit a surface texture that is complex with high relief and sharp peaks.

It is well understood in the matboard market, that the current trend for three-dimensional textured matboard is increasing, and there is a growing desire for new textures, complex textures, thicker textures, and bolder textures. Because the producers of matboard are typically paper manufacturers, the process technologies and material technologies used by these companies to produce two-dimensional, and three-dimensional matboard are paper making technologies and paper embossing technologies. When embossing rolls are used to impart a third dimension into the surface of the paper board, the depth of penetration of the embossing roll into the surface of the paper matboard, is limited by the thickness of the matboard, and as such, it becomes physically and economically impractical to create deep thick textures. Using embossing techniques to create a textured three-dimensional surface that has depth of texture, which approaches or exceeds 0.125 inches would require the thickness of the paperboard substrates to be greater than the thickness of the texture and would exceed 0.0125 inches. Typically the thickness of matboard is 0.050″ to 0.060″, which allows one to efficiently cut the matboard to desired sizes and shapes, and facilitates the application or lamination of the matboard to a supportive substrate.

Furthermore, conventional technologies used to produce flat embossing dies and embossing rolls are incapable of creating the complex textures and designs, that are the subject of this invention. Examples of complex textures are faux finishes commonly used for the decoration of walls, fabrics such as burlap, bamboo, weathered barn wood, carved wood designs, leaves, collages, rough surfaced stone, travertine marble, and artisan created custom designs of sculpted surfaces and the like.

Although textured matboards have been available which are produced using existing technologies, there remains an ongoing need and desire for complex textures and designs. Prior art patent searches and literature searches in the area of mats and matboards have yielded essentially no products or methods that teach the creation of textures and associated imagery as claimed and described in this invention.

Another novel and useful aspect of the invention is a liner comprised of a wooden frame that is covered with textured mats as described by this invention. Liners are inner wood frames that are covered with fabrics and other materials such as leathers, and the like, and are usually positioned adjacent to, and surrounded by, an outer frame that serves as the principal frame. Liners are most often used when framing art works on canvas. Fabric is typically used to add interest, texture, and softness to a frame design. Fabric is the preferred covering used as a wrap-around for liner frames. Fabric liners are easily soiled and are difficult to clean. Materials used as a wrap around are typically flexible fabrics, and more frequently linen is the fabric of choice, and, although leathers and other fabrics are available for this purpose, alternatives to the aforementioned materials are limited. Liners are also available as solid wood and plastic frames, and are available in a variety of finishes that are coated onto the surface of the liner such as; stain finishes, antique finishes, metallic finishes and presumably any finish that can be applied by machine or hand. The surface of liners of this nature can be ornate mechanically created carvings or simple knurled textures.

The use of unique textures and finishes as defined by this invention appear to be unknown, and prior art patent searches and literature searches in the area of mats, matboards, and liners have yielded no products or methods that teach the creation of textures and associated imagery as claimed and described in this invention.

### SUMMARY OF THE INVENTION

The present invention provides an mat and method of making a mat which is practical, reliable, accurate and efficient, and which is believed to fulfill a need and to constitute an improvement over the background technology.

In one aspect, the present invention is a mat comprised of a textured thermoformed plastic layer that is intrinsically colored, i.e.; colored throughout the body of the layer or extrinsically colored i.e.; colored on the surface only, or the textured thermoformed layer may be clear or not colored.

In another aspect, the present invention is a mat laminate comprised of a textured thermoformed plastic layer intrinsically or extrinsically colored or not colored, and bonded to a substrate.

The invention further provides a method of making mats including the steps of:
(a) providing a vacuum source connected to a mold having relief characteristics and with sufficient porosity through which air can effectively be drawn through the mold;
(b) providing a thermoformable plastic layer that is intrinsically or extrinsically colored or not colored;
(c) positioning the thermoformable plastic layer of step (b) on the surface of the mold, and in contact with the surface of the mold or optionally positioning the plastic layer spatially from the surface of the mold, and not in contact with the surface of the mold;
(d) heating the thermoformable plastic layer to a thermoformable state while the layer is not under the influence of an applied vacuum and is on the mold, or optionally while the thermoplastic layer is spatially separated from the mold (optionally, a vacuum may be applied to the thermoplastic layer while in contact with the mold prior to heating); and
(e) applying sufficient vacuum while heated to draw the thermoformable plastic layer into intimate contact with the mold; thereby, forming the thermoformable layer to the same relief characteristics as the mold.

The process optionally includes steps to create colored patterns on the textured surface of mats that have been created using the above process by:
(a) applying one or more continuous or non-continuous color layers to the textured surface of the pre-formed mats by hand, or optionally applying the color layers using mechanical apparatuses; and
(b) highlighting the applied color layers by hand using techniques commonly employed to produce antique finishes, faux finishes, and the like, or, optionally, finishing the applied color layers using mechanical apparatuses.

The invention further provides an alternate method of making mats; whereby, the desired color or color patterns comprising the finish are applied to the flat thermoformable layer prior to forming the thermoformable layer. The color or color patterns may be applied using any of a variety of imaging techniques, such as; screen printing, offset lithography, flexography, inkjet, digital, hand applied colors or patterns, or combinations of these techniques may be employed. The colored thermoformable layer is then formed using the molding process as previously described, but optionally in step (c); positioning the thermoformable layer so that the pre-applied color patterns are in registration with the corresponding relief characteristics of the mold, and after forming, the resultant thermoform is a virtual replica of the master model in both finish and texture.

The foregoing methods as described produce mats useful as perimeter surrounds or, optionally, the mats may be laminated to substrates, such as paperboard and foam sheeting, and the like to provide additional thickness and/or rigidity when required. When mats of the invention are laminated to substrates, such as dry wall and metal sheets, they are useful as decorative surfaces for applications requiring fire resistance, such as walls and ceilings.

Another aspect of the invention is a liner that is created by using the textured thermoformed finished mats of the invention as a layer wrapped around and bonded to a rigid frame molding. The thermoformed layer is textured and may be pre-finished before bonding to the rigid frame molding or may be post-finished after bonding to the rigid frame molding. The materials used as the warp around thermoformed layer should be of sufficient flexibility, to resist breaking when wrapped around sharp corners, while maintaining structural integrity of the texture and finish.

Preferably the materials selected as the thermoformable layer, and the materials used to create the finish are light-stable and; thereby, capable of resisting the discoloration and degradation previously described as deficiencies in paper based products.

Advantageously, the present invention provides new methods and products for the creation and making, of mats and liners for the picture framing market and other applications, comprised of textures and finishes heretofore, unseen and unanticipated; and further provides for materials of construction that meet or exceed the required physical properties to prevent color and product degradation due to aging, UV light, heat, and atmospheric oxidants.

### DETAILED DESCRIPTION

One aspect of the invention is a product and method for creating and producing mats comprised of artisan-created or natural textures that have been imparted to a sheet by a mold that has relief characteristics, that are a perfect duplication of the relief characteristics of the original textures. The formed (molded) sheet is optionally colored before the sheet is formed or after the sheet is formed. Optionally, the mats produced by this method may be used as is, or may be bonded to a substrate.

The process begins by creating or obtaining a textured master model of the desired textures. The textures to be produced may be man made, created by artisans and others, or may be natural occurring textures. Examples of natural occurring textures are stone surfaces, wood surfaces, collages of grasses and leaves, and the like. Examples of man made and artisan-created textures are faux finishes, plasters, crackle, carved wood, woven fabrics, such as silk, burlap, impasto surfaces, hammered-sculpted metals and the like.

A relief mold is made from the master. Relief molds useful for thermoforming are well known and can be made from various materials including metals and porous metal composites, filled and unfilled polymeric resin composites, foamed composites, ceramics, and ceramic composites. Specific materials that are useful include epoxy or urethane resins filled with glass bubbles, beads, silica and the like; silicone rubbers, unfilled or filled with silica, calcium carbonate, and the like; and fabric reinforced epoxy resin composites. Methods of making molds are also well known and include, for example, those methods described in GB 782,703, and U.S. Pat. No. 4,308,224. Preferably, the molds are porous. Porosity can be introduced into the molds by means well known in the art. In areas where there is a deep draw, it may be useful to perforate the bottom of the valley in a mold to ensure sufficient draw to achieve the desired texture. Textures in molds can be enhanced or created by mechanically or chemically machining or etching the mold surface to provide the desired surface textures. The molds can be coated with metal, such as by electroplating, or other hard coatings to increase the life of the molds. Release coatings, such as silicones or fluorocarbons can also be used to coat the mold surface to aid in removal of the finished art reproduction from the mold.

The mold created as described is used to impart texture to a thermoformable plastic layer. Useful materials for the thermoformable layer include, but are not limited to polyvinyl chloride (PVC), polystyrene, ethylene vinyl acetate copolymers, polyvinyl alcohol copolymers, acrylic copolymers, polyester, and nylon. Preferred materials for the thermoformable layer include polystyrene and polyvinyl chloride, which, relative to paper based products, are resistant to discoloration and degradation over time. The thickness of the thermoformable layer used in the molding operation is dependent on the rigidity of the material. Flexible films need to be thicker than rigid films in order for the formed textures to retain structural shape and integrity. Suitable thickness ranges from, but are not limited to, about 0.002 inches and greater for rigid materials, and about 0.004 inch and greater for flexible materials. Polyvinylchloride films are readily available from numerous sources, including Flexcon Company, Inc., Spencer, Mass. These films are acid resistant, color stable and resist degradation over time and are frequently used for outdoor signage. Polystyrene films, although not as light stable as polyvinyl chloride films, but far superior to paper based materials in color stability, are also acid resistant and resist degradation over time. Useful polystyrene films are those that have been plasticized with flexiblizing polymers, and stabilized for resistance to sunlight. Polystyrene films suitable for this purpose can be purchased at various sources, including Pace Industries, Inc., Reedsburg. Wis., and the Dow Chemical Company. Thermoformable materials suitable for the purposes of this invention are readily available as white films/sheets or clear transparent films/sheets. Intrinsically colored films/sheets are available in a variety of colors, and custom colored films can be acquired on special order.

The thermoformable layer is formed to achieve the desired texture by positioning the thermoformable plastic layer on the surface of the relief mold, and heating the thermoformable plastic layer while under the influence of a vacuum, and applying sufficient vacuum while heated to draw the thermoformable plastic layer into intimate contact with the mold; thereby, forming the thermoformable layer to the same relief characteristics as the mold. The resulting product, which may be referred to as a thermoform, may stand alone as a mat suitable for a variety of applications such as matboard for picture surrounds, and optionally, the thermoform, as is, may be processed with additional finishes to achieve a variety of looks. As an example a master model with a crackle finish may be created using faux finishing techniques. From this master a relief mold is made, the surface of which can be either a negative or positive replication of the crackle finish of the master model. A thermoformable sheet 0.010 inch×33 inch×41 inch, comprised of vacuum forming grade white polystyrene, is placed on the mold and is thermoformed under the influence of a vacuum to form a texture that is a crackle finish. The resulting thermoform is an intrinsically colored white sheet comprised of a crackle texture that is useful as a perimeter surround for image displays.

The invention provides for the creation and production of mats comprised of varieties of finishes that may be created on the same texture. For example, the white crackle thermoform described in the preceding paragraph may be embellished by coating or staining the surface of the thermoform with additional colors, and wiping the coatings to create highlights and other decorative artistic effects. The process may be repeated with additional colors and highlights as often as desired. Highlighting may be accomplished by hand wiping or mechanical applicators and wipers may be employed; and patterns may be applied using screen-printing techniques. Useful products for creating colors are paints and stains that are commonly found in hardware stores and paint stores, such as Hirshfield's Paint Manufacturing, Inc. and The Sherwin Williams Company. Practically any physical texture may be enhanced or embellished with the aforementioned techniques, examples of which are: stone surfaces, wood surfaces, collages of grasses and leaves, faux finishes, plasters, carved wood, woven fabrics, such as silk, burlap, and the like.

Alternatively a mat may be produced by finishing the thermoformable layer prior to molding the thermoformable layer. The pre-applied finish may be created by using artisans to create finishes, and artistic patterns that may be highlighted mechanically or by hand on the pre-formed thermoformable layer. Alternatively, the pre-applied finish may be created by imaging the desired pattern on the surface of the thermoformable layer prior to molding. The patterns may be applied using any of a variety of imaging techniques, such as: screen printing, offset lithography, flexography, inkjet, digital or a combination thereof. The pre-finished thermoformable layer is next formed in a relief mold to impart the texture of the mold to the now thermoformed sheet. The imagery of the pre-applied finish may or may not be in registry with the texture. If registration of texture and imagery is required, the process for creating mats requires the additional steps of creating a master model that is comprised of both texture and a finish, and subsequently capturing the imagery of the surface of the model using any of the many image replication techniques available such as scanners and cameras. Typically, the surface of a finished master model can be easily copied using a digital scanner, which will create a digital file of the colors and patterns that comprise the surface of the master model. Once copied the data file from the scanner may be used in the printing process to create an image that is exactly the same, in size and imagery, as the original master model. The image is then printed on the surface of a thermoformable layer, and is positioned in a relief mold by registering the imagery of the printed thermoformable layer with the corresponding relief characteristics of the mold, and subsequently applying heat and a vacuum to form the layer to the shape of the relief mold.

The invention further provides for a preferred method that teaches how a given texture can be produced in a variety of finishes without the need to create new master models with different finishes. Using Adobe's Photoshop digital imaging software, which is known to those skilled in the art and is used to manipulate or enhance digital photographs and to create original digital artwork, the digital data file of a scanned finished master model, as defined in the previous paragraph, may be manipulated to create any desired finish. The finish of choice is then printed on the surface of the thermoformable layer, which results in a new rendition having a given texture with a different finish. The thermoformable layer, now comprised of a different finish and given texture, is formed in the manner as described in the previous paragraph. The process is especially useful for commercial production of mats by providing a means by which a mold/molds of a given texture can be used to produce an extended line of different finishes. Alternately, an extended line of different finishes pre-applied to a thermoformable layer may be achieved by (a) creating new finishes on the surface of the master model, (b) scanning the surface to create a new digital file, and (c) printing the new finish on thermoformable layers and forming into mats as previously described. The alternate method may be preferred for those not skilled in the use of Photoshop, or for those instances where the desired finish is not achievable with digital manipulation but is easily created by artisans. The process may be repeated as often as necessary.

Another aspect of the invention is the option of bonding the thermoformed mats as described to a substrate for the purpose of creating thickness. In the framing market, paperboard mats when used to frame a picture, are often used in multiple layers to create depth. Those skilled in the art of framing will readily understand the need for thickness where depth is required. The thermoforms of the invention, thus far described, are of insufficient thickness for this purpose and require lamination to a substrate that will provide the required thickness. Examples of substrates suitable for this purpose are paperboard, polymer foams, and foam-paper laminates.

Paper based matboard products being sold in the framing market work surprising well as a substrate. It is well known by those skilled in the area of paperboard that moisture in the air causes undesirable warping, of the board, and matboard manufacturers construct paper based products to minimize this effect. It is well known that, if one surface of the paperboard is more moisture absorbent than the opposite surface, the entire structure will warp concavely relative to the lesser moisture absorbing surface when moisture levels are high, and conversely, the structure will warp convexly when moisture levels are low. It is also well known that laminates comprised of plastic and paper require a plastic layer on both surfaces of the paper to maintain flatness. Surprisingly, the textured thermoformed paperboard laminates of this invention remain functionally flat when exposed to typical summer and winter indoor climates.

The substrate is adhered to the thermoformed mat with an adhesive. Useful adhesives include but are not limited to, pressure-sensitive adhesives; water and solvent based laminating adhesives, and the like. Suitable adhesives include acrylic adhesives, block copolymer adhesives, poly (urethane) adhesives, poly (ethylene vinyl acetate) adhesives, poly (vinyl acetate) adhesives, and the like. A particularly useful class of adhesives is pressure-sensitive adhesives. These adhesives are tacky at room temperature and can be selected to adhere well to most materials. Acrylic pressure-sensitive adhesives are preferred because of their excellent aging properties, clarity, and resistance to aging. They are commercially available in various forms, which include, but are not limited to water borne latexes, solvent based adhesives, spray adhesives, and free films or transfer tape. Examples of useful commercial pressure-sensitive adhesives are adhesive transfer tapes sold by Minnesota Mining & Manufacturing Company, St. Paul Minn., under the SCOTCH trademark, spray adhesives, available from Minnesota Mining & Manufacturing Company under the 3M trademark, and various acrylic pressure-sensitive adhesive from Rohm & Haas.

The adhesive can be disposed between the thermoform and the substrate by several methods; e.g., coating adhesive onto the substrate; coating the backside of the thermoform, or both. The adhesive can also be provided as a free film, which may be laminated to either the substrate, the backside of the thermoform, or the thermoformable layer. Alternatively, adhesive coated thermoformable films are commercially available from companies such as 3M Company, Flexcon, and Avery International.

The physical act of laminating the layers may be achieved by any of several methods including, but not limited to, rolling by hand or passing through mechanical rollers or by the use of a vacuum laminator. Excessive pressure during the laminating process may cause damage to the texture of the thermoform The use of a sheet of flexible foam, of sufficient thickness interposed between the surface of the thermoform and the surface of the laminator, prevents damage to the texture.

Alternatively, lamination may be achieved by the use of strips of ATG double-sided tape, which is commonly used for mounting photos or artwork where two adhesive surfaces are required. The ATG tape can be used with or without an applicator. This method of lamination is useful for those who prefer to acquire textured mats, that are freestanding thermoformed layers, not laminated to a substrate, and perform the required lamination on-site as required.

Examples of non-limiting specific embodiments of the invention are as follows: A master model with a barn-wood finish was prepared by assembling several weathered cedar boards taken from an actual aged building structure. The boards were joined together side by side in a flat 0.75 inch by 48 inch by 54 inch rectangular pattern. A digital image file of the surface of the master model was created by scanning the master model with a large format flatbed scanner.

A flexible rubber mold was made by pouring RTV silicone, liquid rubber, molding compound onto the surface of the master model, and allowing the RTV silicone to cure (harden) at room temperature. After curing at room temperature to a flexible harden state, the RTV rubber mold, which is now an exact negative relief replication of the surface texture of the master model, was removed from the master model. The RTV mold was used to create a vacuum forming mold comprised of negative relief texture using technologies previously described.

A thermoformable layer was prepared by printing an image of the barn-wood surface on a 0.010 inch thick polyvinylchloride film. The printing was done using a Roland, 60 inch wide roll-to-roll inkjet printer. The resulting printed sheet was cut into a rectangle measuring 34 inches by 44 inches with the image centered on the sheet and with registration marks. A mold having relief characteristics corresponding to the desired texture of the master model was placed on a thermoforming table and attached to a vacuum pump. The printed sheet was then positioned over the mold with the printed side facing the mold and with the relief areas of the mold in registry with the corresponding printed areas of the printed sheet. Registration was achieved by aligning two of the registration marks on the sheet with pins on the mold. A vacuum of approximately 20 inches of mercury was then applied to the mold to hold the sheet in place. The edges of the sheet were taped to the mold with a film packaging tape and the table was positioned under a bank of infrared heaters positioned about 8 inches from the surface of the thermoformable layer sheet for 1.5 minutes. During this time the printed sheet was drawn into the mold and acquired the relief characteristics of the mold to form a textured finished sheet. After cooling to about 100 F. the thermoform was removed from the mold and the edges were trimmed. The resultant thermoform had an excellent pattern and color fidelity as well as excellent relief characteristics that were in perfect registry with the printed patterns.

The process may be repeated to produce a limitless line of colored finishes on thermoforms all of the same texture, and it becomes apparent that employing molds of different textures allows for the creation and production of mats comprised of limitless colored finishes and textures.

Some of the mats as described were bonded to a substrate as follows. The unfinished side of an untrimmed thermoformed mat was coated with a layer of Robobond 2000 pressure sensitive adhesive, made by Rohm and Haas, using a short nap paint roller and allowed to dry for four hours. The resulting thickness of the dried adhesive layer ranged from 0.015 inches to 0.002 inches. White paper based matboard 32 inches by 40 inches manufactured by Crescent Matboard Company was placed on the bed of a vacuum forming press, after which, the adhesive coated thermoformed mat of the invention, which is two inches longer in each direction than the paper based matboard, was placed adhesive side down onto the surface of the paper based matboard. A one inch thick, soft, closed cell sheet of polyurethane foam was placed on top of the thermoformed mat. The top rubber bladder of the vacuum forming press was placed over the three layers and a vacuum was applied, effectively removing all the air under the bladder and creating sufficient pressure to laminate the thermoform to the paper based matboard. The resultant laminate was removed from the press and the overlapping edges of the thermoform were removed.

Another specific embodiment of the invention comprises a thermoform, the finish of which, has been applied after the thermoformable layer has been formed. Referring to the preceding embodiment, a white, thermoformable HIPS (high impact polystyrene) polystyrene sheet, 34 inches wide by 0.010 inches thick by 44 inches long, was placed on the surface of the mold and thermoformed as previously described. The resultant thermoformed mat, which is comprised of a white finish and barn-wood texture may be used as is, or may undergo further processing to apply additional colored finishes; e.g. a first color was applied by spraying a continuous solid color layer of Hirschfield's Prowall 2000, and allowed to dry. The resultant colored textured thermoform is a mat and may be used as is, or may undergo additional processing; e.g. a second discontinuous color layer of Prowall 2000 diluted with Hirshfield's Faux Finishing Glaze was applied by hand, hand-highlighted, and allowed to dry. The resultant twice colored textured thermoform is a mat and may be used as is, or may undergo additional processing. A third color using Prowall 2000 diluted with Hirshfield's Glaze was sparsely applied by hand. The resultant thrice colored textured thermoform is a mat and may be used as is. The process may be repeated to produce a limitless line of colored finishes on thermoforms all of the same texture, and it becomes apparent that employing molds of different textures allows for the creation and production of thermoformed mats comprised of near limitless colored finishes and textures.

Another novel and useful aspect of the invention is a liner comprised of a wooden frame covered with a wrap around textured mat that is produced using the methods described in this invention. The thermoformable layer used to produce liners must be of sufficient flexibility to prevent cracking while being wrapped around sharp corners, but, also, must be of sufficient stiffness to maintain the textures that have been imparted into the layer prior to wrapping.

The preferred thermoformable layers of the invention are polyvinylchloride polymer films, which are commercially available with varying degrees of stiffness referred to as “hand”. “Hand” is a measure of stiffness and flexibility. Polystyrene and polyvinylchloride, in the pure state, are very brittle materials and easily fracture or break. Flexibility is imparted to these polymers by the addition of varying amounts of plasticizers (flexible polymers) that soften or make the harder polymers more flexible. Stiffness ranges from hard to very soft with soft having more plasticizer. According to the industry measurements, a hand of about 24 is soft. A hand ranging between about 12 to 17 is referred to as semi-rigid, while lower numbers are used to describe harder polymers having little or no plasticizer. In the practice of the invention, PVC films having a hand greater than about 10 are preferred. A hand greater than about 18 is preferred where very flexible materials are required. Commercially available products suitable for the purpose of creating liners are polyvinylchloride films with a “hand” of, but not limited to, 10 to 18. Polyvinylchloride films manufactured by Flexcon Corporation, and designated as flexible, have been found suitable for this invention.

In one embodiment of the invention a textured thermoformed layer of the invention was created using FLEXmark V400 F, which is a 4.0 mil flexible, white, opaque, polyvinylchloride film, manufactured by FLEXcon of Spenser, Massachusetts, and subsequently bonded to a rigid wooden frame molding having a triangular cross-sectional shape. The length of the wooden frame was two feet, and the dimensions of the right triangle forming the cross-section were one inch wide by three eighths inch thick. The angles of the triangle were, 90, 34 and 56 degrees. The corners of the triangle were rounded to a radius of about one eighth inch. The backside of thermoformed layer, which was about two feet four inches long by four inches wide, and the surface of the wooden frame were sprayed with 3M Super 77 Spray Adhesive. The adhesive coated thermoformed layer was wrapped around the wooden frame covering all three angles and overlapping on the backside of the wooden frame, from which, the excess over lap was removed. The thermoform was well bonded to the wooden frame and no noticeable cracking or breaking was evident at the corners.

An alternate embodiment of the invention is to: (a) create a mold from a master model of a frame having the exact shape, texture and finish required; (b) forming an imaged thermoformable layer in the mold; (c) filling the back side cavity of the thermoform with a foam or reactive epoxies and polyurethanes, or cementitious materials; (d) allow the backfill to harden; and (e) remove the composite from the mold and trim excess materials. The resultant composite is comprised of a thermoformed layer backfilled with a rigid material. The composite is now a finished textured framing material that can be used as a liner or can be fashioned into a frame suitable for the framing of art, photos, and the like.

The invention has been described in the best mode of making and using the present invention at the time of filing. One can see that various modifications, some of which have been mentioned, can be made without departing from the spirit and scope of the invention as is set forth in the claims below:

1. A mat comprising a textured plastic sheet having an exposed decorative surface.

2. A mat according to claim 1, wherein the textured plastic sheet is intrinsically colored, or extrinsically colored, or both intrinsically and extrinsically colored, or not colored.

3. A mat according to claim 1, wherein the plastic sheet and the exposed decorative surface are comprised of materials resistant to degradation caused by exposure to light and atmospheric oxidants.

4. A mat according to claim 1, wherein the plastic sheet is a thermoformable polymer.

5. A mat according to claim 1, wherein the plastic sheet is polyvinylchloride or polystyrene.

6. A mat according to claim 1, further comprising a pressure sensitive adhesive disposed on the plastic sheet on the side opposite the exposed decorative surface

7. A mat according to claim 1, further comprising a substrate layer, and wherein the plastic sheet is laminated to the substrate layer on the side opposite the exposed decorative surface.

8. The mat of claim 7, wherein the substrate layer is a paper or cotton material.

9. The mat of claim 7, wherein the substrate layer comprises a polymer material.

10. The mat of claim 7, wherein the substrate layer comprises a fire resistant material.

11. The mat of claim 7, wherein the substrate layer comprises a wood material.

12. A method for making a mat comprising the steps of:
(a) providing a mold with relief characteristics;
(b) providing a thermoformable plastic sheet;
(c) positioning the thermoformable plastic sheet with respect to a surface of the mold, and in contact with the surface of the mold, or spatially away from the surface of the mold;
(d) heating the plastic sheet to a thermoformable state while the sheet is not under the influence of an applied vacuum, and the plastic sheet is on the mold; or heating the plastic sheet while the plastic sheet is spatially separated from the mold, and
(e) applying vacuum and heat to draw the plastic sheet into the relief characteristics of the mold.

13. The method of claim 12, wherein plastic sheet is colored.

14. The method of claim 12, further comprising the step, prior to heating, of applying a vacuum to the plastic sheet while the plastic sheet is in contact with the mold.

15. The method of claim 12, further comprising the step of embellishing the surface of the plastic sheet, by applying, with mechanical apparatuses or by hand, one or more continuous or discontinuous color layers to the exposed surface of the plastic sheet.

16. The method of claim 15, further comprising the step of highlighting the applied color layers of step, one layer at a time or all layers at a time, by hand or by mechanical apparatuses.

17. The method of claim 12 further comprising the step of creating a plurality of plastic sheets having the same texture, and subsequently coloring the plastic sheets to create numerous editions of decorative finishes.

18. A method for making a mat comprising the steps of:
(a) providing a surface that is comprised of surface relief characteristics;
(b) providing a mold comprised of mold relief characteristics similar to, or the same as, the surface relief characteristics;
(c) providing a plastic sheet having an image on at least one surface, optionally, having the image correspond to the image and relief characteristics of the mold;
(d) positioning the imaged thermoformable plastic sheet with respect to the mold on the surface of the mold, and in contact with the surface of the mold;
(e) heating the thermoformable plastic sheet to a thermoformable state while the sheet is not under the influence of an applied vacuum and the plastic sheet is on the mold, or, while the thermoplastic sheet is spatially separated from the mold; and
(f) applying sufficient vacuum and heat to draw the thermoformable plastic sheet into the relief characteristics of the mold.

19. The method of claim 18, further comprising the step of positioning the plastic sheet spatially from the surface of the mold, and not in contact with the surface of the mold.

20. The method of claim 18, further comprising the step of positioning the plastic sheet, that has been imaged with the relief characteristics of the mold, so that the image is in registration with the corresponding relief characteristics of the mold.

21. The method of claim 18, further comprising the setp, prior to heating, of applying a vacuum to the thermoplastic sheet while the sheet is in contact with the mold.

22. The method of claim 18 further comprising the step of creating numerous editions of decorative finishes having the same texture and the same patterns, but of different colors, by altering the color scheme of the original digital file that was used to image the thermoformable plastic sheet.

23. A frame comprising a textured plastic sheet having an exposed decorative surface bonded to a shaped substrate.

24. The frame of claim 23 wherein the textured decorative-plastic sheet is wrapped around and adhesively bonded to the shaped substrate, the textured thermoformed plastic sheet having sufficient flexibility and stiffness so that, when wrapped around a substrate, the textured thermoformed plastic sheet will not crack, and the structural integrity of the texture remains functionally intact.

25. The frame of claim 23 wherein the shaped substrate comprises a wood material.

26. The frame of claim 23 wherein the shaped substrate comprises a polymer material.

27. The frame of claim 23 wherein the shaped substrate comprises a cementitious material.

28. A frame comprising a thermoformed plastic sheet having a predetermined length a decorative textured surface and a cross sectional shape of a frame defining a cavity, the cavity being backfilled with a hardened material.

29. The frame of claim 28 wherein the backfill is a polymer material.

30. The frame of claim 28 wherein the backfill is a cementitious material.
